(19) United States
(12) Patent Application Publication
(10) Pub. No.: US 2012/0073722 A1
(43) Pub. Date: Mar. 29, 2012

(54) PNEUMATIC TIRE

(75) Inventors: Hiroshi Hata, Hiratsuka-shi (JP); Yoshiaki Hashimura, Hiratsuka-shi (JP)

(73) Assignee: THE YOKOHAMA RUBBER CO., LTD., Tokyo (JP)

(21) Appl. No.: 13/231,725

(22) Filed: Sep. 13, 2011

(30) Foreign Application Priority Data
Sep. 27, 2010 (JP) 2010-215123
May 31, 2011 (JP) 2011-121384

(51) Int. Cl. B60C 9/02; B60C 9/18

(52) U.S. Cl. 152/535; 152/548; 152/552

(57) ABSTRACT

A pneumatic tire including a carcass layer wherein reinforcing cords are arranged in a tire circumferential direction and ends thereof in a tire width direction extend to bead cores disposed in bead portions of both sides; and a belt layer including a layer provided on an outer side in a tire radial direction of the carcass layer. A range, inward in the tire width direction of ends of the belt layer in the tire width direction, is not less than 5% and not more than 95% of a maximum dimension of the belt layer in the tire width direction; and a carcass strength coefficient K of the carcass layer defined by the formula [carcass strength coefficient K (N/mm·kPa)]=[reinforcing cord count (cords/mm)]×[reinforcing cord strength (N/cord)]×[number of carcass layers]÷[maximum air pressure (kPa)] is such that 0 (N/mm·kPa)<K<0.15 (N/mm·kPa).

### PRIORITY CLAIM

Priority is claimed to Japan Patent Applications Serial No. 2010-215123 filed on Sep. 27, 2010 and Serial No. 2011-121384 filed on May 31, 2011.

### BACKGROUND

1. Technical Field

The present technology relates to a pneumatic tire having enhanced uniformity of a tread.

2. Related Art

Conventional pneumatic tires are known in which a carcass layer is segmented in a tire width direction in order to enhance riding comfort (e.g. Japanese Unexamined Patent Application Publication No. 2008-037265A).

However, with conventional pneumatic tires as described above, a dividing portion of the carcass layer may swell when molding, which leads to nonuniformity of the tread gauge. As a result a tread portion will deform, leading to a pejorative effect on ground contact form, and riding comfort will decline.

### SUMMARY

In light of the foregoing, the present technology provides a pneumatic tire that can maintain the same level of riding comfort as a form in which the carcass layer is divided and in which uniformity of the tread gauge can be enhanced.

A pneumatic tire of the present technology includes a carcass layer wherein a plurality of reinforcing cords is arranged in a tire circumferential direction and ends thereof in a tire width direction extend to bead cores disposed in bead portions of both sides; and a belt layer including at least one layer provided on an outer side in a tire radial direction of the carcass layer in a tread portion. A range W2, which is inward in the tire width direction of ends of the belt layer in the tire width direction, is not less than 5% and not more than 95% of a maximum dimension W1 of the belt layer in the tire width direction; and a carcass strength coefficient K of the carcass layer defined by the formula [carcass strength coefficient K (N/mm·kPa)]=[reinforcing cord count (cords/mm)]×[reinforcing cord strength (N/cord)]×[number of carcass layers]÷[maximum air pressure (kPa)] is such that 0 (N/mm·kPa)<K<0.15 (N/mm·kPa).

A structure in which the carcass layer is segmented is indicated by a carcass strength coefficient K of zero (0). In such cases, a dividing portion of the carcass layer may swell when molding, which leads to nonuniformity of the tread gauge. Thus, by configuring the carcass strength coefficient K of the carcass layer such that 0 (N/mm·kPa)<K, swelling of the carcass layer will be prevented and the uniformity of the tread gauge will tend to be enhanced. On the other hand, when carcass strength coefficient K≧0.15, the reinforcing cord count, the reinforcing cord strength, and the number of carcass layers increases, which leads to a tendency for an increase in tire weight and a decrease in riding comfort. Therefore, according to this pneumatic tire, by configuring the carcass strength coefficient K of the carcass layer so as to be 0 (N/mm·kPa)<K<0.15 (N/mm·kPa) in a given range of the tire width direction defined by the belt layer, the same level of riding comfort as a form in which the carcass layer is segmented can be maintained and uniformity of the tread gauge can be enhanced.

Additionally, with the pneumatic tire of the present technology, the carcass strength coefficient K is calculated using a range that is inward in the tire width direction of a position that is at least 10% of a maximum dimension of the belt layer in the tire width direction from both ends of the belt layer in the tire width direction.

Narrowing the range used in calculating the carcass strength coefficient K so as to be inward in the tire width direction leads to the enhancement of the uniformity of the tread gauge at a center portion of the carcass layer in the tire width direction, which is prone to swelling. Therefore, according to this pneumatic tire, a significant enhancement in the uniformity of the tread gauge can be obtained.

Additionally, with the pneumatic tire of the present technology, the reinforcing cord count of the carcass layer used in calculating the carcass strength coefficient K is at least 3 (cords/50 mm).

It is preferable that the reinforcing cord count be at least 3 (cords/50 mm) because swelling of the carcass layer will be prevented. Therefore, according to this pneumatic tire, a more significant enhancement in the uniformity of the tread gauge can be obtained.

Moreover, with the pneumatic tire of the present technology, the reinforcing cord strength of the carcass layer used in calculating the carcass strength coefficient K is at least 2 (N/cord).

It is preferable that the reinforcing cord strength be at least 2 (N/cord) because swelling of the carcass layer will be prevented. Therefore, according to this pneumatic tire, a more significant enhancement in the uniformity of the tread gauge can be obtained.

Additionally, with the pneumatic tire of the present technology, the carcass layer includes a dividing portion that is delimited by the range defined by the belt layer, and a reinforcing portion provided so as to straddle the dividing portion, wherein the reinforcing portion is used in calculating the carcass strength coefficient K.

When using the range in the tread portion in calculating the carcass strength coefficient K, in order to maintain durability of the tire, a given carcass strength coefficient is needed that reaches the bead portions that are the outer sides of the range in the tire width direction. Therefore, according to this pneumatic tire, strength is appropriately maintained through to the bead portions that are the outer sides of the range in the tire width direction due to a main body of the carcass layer provided so that both ends thereof in the tire width direction fold up and around the bead cores that are disposed in both of the bead portions from the inner side in the tire width direction. Furthermore, by providing the dividing portion and calculating the carcass strength coefficient K using the reinforcing portion, riding comfort can be maintained and a significant enhancement in the uniformity of the tread gauge can be obtained.

With the pneumatic tire of the present technology, riding comfort can be maintained and the uniformity of the tread gauge can be enhanced.

### BRIEF DESCRIPTION OF THE DRAWINGS

FIG. 1 is a meridian cross-sectional view of a pneumatic tire according to an embodiment of the present technology.

FIG. 2 is a schematic meridian cross-sectional view illustrating another arrangement of a carcass layer of a pneumatic tire according to the embodiment of the present technology.

FIG. 3 is a schematic meridian cross-sectional view illustrating another arrangement of a carcass layer of a pneumatic tire according to the embodiment of the present technology.

FIG. 4 is a schematic meridian cross-sectional view illustrating another arrangement of a carcass layer of a pneumatic tire according to the embodiment of the present technology.

FIG. 5 is a table showing results of performance testing of pneumatic tires according to examples of the present technology.

FIG. 6 is a schematic meridian cross-sectional view illustrating an arrangement of a carcass layer of a pneumatic tire of Comparative Example 1 according to the examples of the present technology.

FIG. 7 is a schematic meridian cross-sectional view illustrating an arrangement of a carcass layer of a pneumatic tire of Comparative Example 2 according to the examples of the present technology.

FIG. 8 is a graph showing a range of the carcass strength coefficient of the pneumatic tire according to the examples of the present technology.

### DETAILED DESCRIPTION

An embodiment of the present technology is described below in detail based on the drawings. However, the present technology is not limited to this embodiment. The constituents of the embodiment include constituents that can be easily replaced by those skilled in the art and constituents substantially same as the constituents of the embodiment. Furthermore, the multiple modified examples described in the embodiment can be combined as desired within the scope apparent to a person skilled in the art.

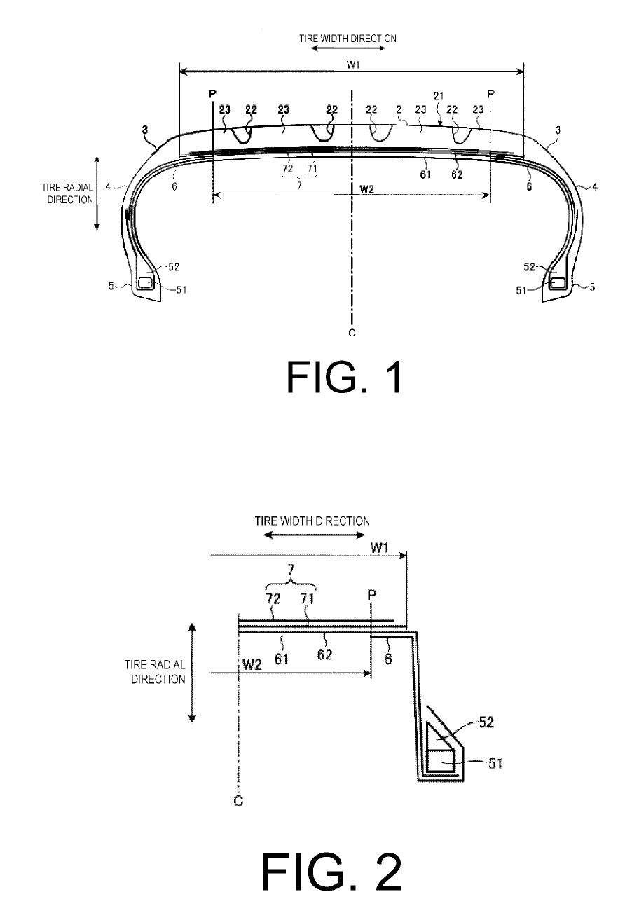

FIG. 1 is a meridian cross-sectional view of a pneumatic tire according to this embodiment. In the following description, “tire radial direction” refers to a direction orthogonal to the rotational axis (not shown) of the pneumatic tire; “inner side in the tire radial direction” refers to the side facing the rotational axis in the tire radial direction; and “outer side in tire radial direction” refers to the side distanced from the rotational axis in the tire radial direction. “Tire circumferential direction” refers to a circumferential direction with the rotational axis as a center axis. Additionally, “tire width direction” refers to the direction parallel to the rotational axis; “inner side in the tire width direction” refers to the side that is near to a tire equatorial plane C in the tire width direction; and “outer side in the tire width direction” refers to the side that is far from the tire equatorial plane C in the tire width direction. “Tire equatorial plane C” refers to a plane that is orthogonal to the rotational axis of the pneumatic tire and that passes through a center of a tire width of the pneumatic tire. The tire width is a width in the tire width direction between constituents located to the outside in the tire width direction, or in other words, the distance between the constituents that are most distant in the tire width direction from the tire equatorial plane C. Furthermore, “tire equator” refers to a line in the circumferential direction of the pneumatic tire that lies on the tire equatorial plane C. In this embodiment, “tire equator” is given the same “C” reference symbol that used for the tire equatorial plane. Note that, the pneumatic tire described below is constructed to be essentially symmetric around the tire equatorial plane C, and therefore, in the meridian cross-sectional view where the pneumatic tire is cut by a plane that passes through the rotational axis of the pneumatic tire (FIGS. 2 to 4, 6, and 7), only one side (the right side in the drawings) centered on the tire equatorial plane C is illustrated, and only this one side is described. A description of the other side (the left side in the drawings) is omitted.

As illustrated in FIG. 1, the pneumatic tire according to this embodiment includes a tread portion 2, shoulder portions 3 on both sides thereof, side wall portions 4 that are consecutively connected to each of the shoulder portions 3, and bead portions 5. Furthermore, the pneumatic tire includes a carcass layer 6 and a belt layer 7. The tread portion 2 is exposed at an outermost side in the tire radial direction of the pneumatic tire and a surface thereof is constitutes a profile of the pneumatic tire. A tread surface 21 is formed on a peripheral surface of the tread portion 2 or, rather, on a road contact surface that contacts a road surface when traveling. The tread surface 21 is provided with a plurality of land portions 23 that are partitioned by a plurality of circumferential main grooves 22 (four in this embodiment) that are formed extending in the tire circumferential direction.

The shoulder portions 3 are locations on both outer sides in the tire width direction of the tread portion 2. Additionally, the side wall portions 4 are exposed at an outermost side in the tire width direction of the pneumatic tire. The bead portions 5 include a bead core 51 and a bead filler 52. The bead core 51 is formed by winding a steel wire (bead wire) in a ring-like manner. The bead filler 52 is disposed in space formed by ends of the carcass layer 6 in the tire width direction being folded up at a position of the bead core 51.

The ends of the carcass layer 6 in the tire width direction are folded over the pair of bead cores 51 from the inner side in the tire width direction to the outer side in the tire width direction, and the carcass layer 6 is stretched in a toroidal shape in the tire circumferential direction to form the framework of the tire. The carcass layer 6 is formed by covering organic fiber (e.g. nylon, polyester, etc.; not illustrated) reinforcing cords with a coating rubber. The reinforcing cords are provided in the tire circumferential direction or, rather, at an angle of 90° (including angles ±5°) with respect to the tire equator C.

Additionally, the carcass layer 6 includes a dividing portion 61, delimited in a given range in the tire width direction in the tread portion 2, and a reinforcing portion 62 provided so as to straddle the dividing portion 61. Specifically, as illustrated in FIG. 1, the main body of the carcass layer 6 is provided so as to be folded over the bead cores 51 from the inner side in the tire width direction to the outer side in the tire width direction and to be divided in the tire width direction at a position corresponding with the tread portion 2. The portion between ends on the inner side in the tire width direction of the segmented main body of the carcass layer 6 constitutes the dividing portion 61. The reinforcing portion 62 is laminated on an outer side of the main body of the carcass layer 6 in the tire radial direction so as to straddle the dividing portion 61 at a position corresponding with the tread portion 2. The reinforcing portion 62 constitutes a portion of the carcass layer 6 and is formed by covering organic fiber (e.g. nylon, polyester, etc.) reinforcing cords (not illustrated) with coating rubber. The reinforcing cords are provided in the tire circumferential direction or, rather, at an angle of 90° (including angles ±5°) with respect to the tire equator C.

Additionally, as illustrated in FIG. 2, the main body of the carcass layer 6 is provided so as to be folded over the bead cores 51 from the inner side in the tire width direction to the outer side in the tire width direction and to be segmented in the tire width direction at a position corresponding with the tread portion 2. The portion between ends on the inner side in the tire width direction of the segmented main body of the carcass layer 6 constitutes the dividing portion 61. The reinforcing portion 62 is laminated on the outer side of the main body of the carcass layer 6 in the tire radial direction so as to straddle the dividing portion 61 at the position corresponding with the tread portion 2. The ends on the outer side in the tire width direction are provided from the inner side in the tire width direction of the bead cores 51 to the outer side in the tire width direction of the bead cores 51. The reinforcing portion 62 is formed by covering organic fiber (e.g. nylon, polyester, etc.) reinforcing cords (not illustrated) with coating rubber. The reinforcing cords are provided in the tire circumferential direction or, rather, at an angle of 90° (including angles ±5°) with respect to the tire equator C.

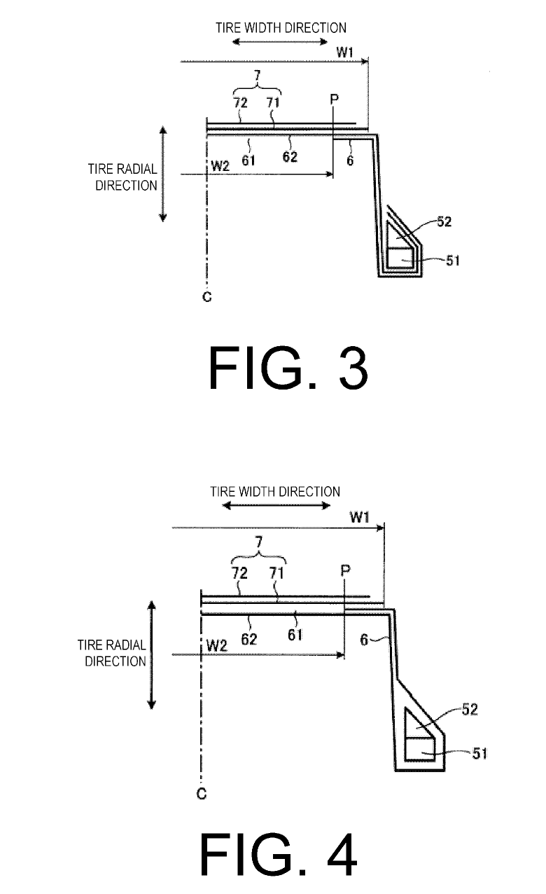

Additionally, as illustrated in FIG. 3, the main body of the carcass layer 6 is provided so as to be folded over the bead cores 51 from the inner side in the tire width direction to the outer side in the tire width direction and to be segmented in the tire width direction at a position corresponding with the tread portion 2. The portion between ends on the inner side in the tire width direction of the segmented main body of the carcass layer 6 constitutes the dividing portion 61. The reinforcing portion 62 is laminated on the outer side of the main body of the carcass layer 6 in the tire radial direction so as to straddle the dividing portion 61 at the position corresponding with the tread portion 2. The ends on the outer side in the tire width direction are provided with the main body of the carcass layer 6 so as to be folded over from the inner side in the tire width direction of the bead cores 51 to the outer side in the tire width direction of the bead cores 51. The reinforcing portion 62 is formed by covering organic fiber (e.g. nylon, polyester, etc.) reinforcing cords (not illustrated) with coating rubber. The reinforcing cords are provided in the tire circumferential direction or, rather, at an angle of 90° (including angles ±5°) with respect to the tire equator C.

Additionally, as illustrated in FIG. 4, the main body of the carcass layer 6 is provided so as to be folded over the bead cores 51 from the inner side in the tire width direction to the outer side in the tire width direction and the folded over ends are provided so as to extend to the tread portion 2 and to be opposite having the given range therebetween in the tire width direction. The portion between the folded over ends of the main body of the carcass layer 6 constitutes the dividing portion 61. The reinforcing portion 62 is a portion provided so as to straddle the dividing portion 61 at the position corresponding with the tread portion 2.

The belt layer 7 includes at least one layer. The belt layer 7 is disposed on an outer side in the tire radial direction that is the periphery of the carcass layer 6, in the tread portion 2 and covers the carcass layer 6 in the tire circumferential direction. The belt layer 7 is formed by covering reinforcing cords made from organic fiber (e.g. nylon, polyester, etc.; not illustrated), steel, or the like with a coating rubber. When the belt layer 7 includes one layer, the cords are provided in the tire circumferential direction; or, rather, parallel with the tire equator C.

As illustrated in FIGS. 1 to 4, the belt layer 7 of the pneumatic tire of this embodiment has a multi-layer structure wherein belt layers 71 and 72 are layered. The cords of the belt layers 71 and 72 are provided in the tire circumferential direction or, rather, at a given angle with respect to the tire equator C, and are provided so that the cords reciprocally cross.

Thus, the pneumatic tire of this embodiment includes the carcass layer 6 wherein the plurality of reinforcing cords is arranged in the tire circumferential direction and ends thereof in the tire width direction extend to the bead cores 51 disposed in the bead portions 5 of both sides; and the belt layer 7 including at least one layer provided on the outer side in the tire radial direction of the carcass layer 6 in the tread portion 2. Moreover, in this pneumatic tire, the range W2, which is inward in the tire width direction of the ends of the belt layer 7 in the tire width direction, is not less than 5% and not more than 95% of the maximum dimension W1 in the tire width direction of the belt layer 7; and the carcass strength coefficient K of the carcass layer defined by the formula [carcass strength coefficient K (N/mm·kPa)]=[reinforcing cord count (cords/mm)]×[reinforcing cord strength (N/cord)]×[number of carcass layers]÷[maximum air pressure (kPa)] is such that 0 (N/mm·kPa)<K<0.15 (N/mm·kPa).

Here, when the belt layer has a multi-layer structure, the maximum dimension W1 in the tire width direction of the belt layer 7 is a dimension in the tire width direction at a maximum width of the belt layer in the tire width direction. Additionally, a position P that is a position not less than 5% and not more than 95% of the maximum dimension W1 in the tire width direction from the ends of the belt layer 7 in the tire width direction, is within the maximum dimension W1 in the tire width direction of the belt layer 7, and the range of not less than 5% and not more than 95% indicates the position of both ends. Moreover, a configuration is included in which a first end in the tire width direction of the belt layer 7 is the position P, and the range inward in the tire width direction of this first end in the tire width direction is not less than 5% and not more than 95% of the maximum dimension W1 in the tire width direction of the belt layer 7.

Additionally, the range W2 in which the carcass strength coefficient K of the carcass layer 6 is such that 0 (N/mm·kPa)<K<0.15 (N/mm·kPa) is a range wherein the reinforcing portion 62 is provided in the dividing portion 61 of the carcass layer 6.

A structure in which the carcass layer 6 is segmented by the dividing portion 61 is indicated by carcass strength coefficient K=0. Because such a configuration is one of a conventional pneumatic tire that does not include the reinforcing portion 62, a dividing portion of the carcass layer may swell when molding, which leads to nonuniformity of the tread gauge. Thus, by configuring the carcass strength coefficient K of the carcass layer 6 to be 0 (N/mm·kPa)<K, deformation of the carcass layer will be prevented and the uniformity of the tread gauge will tend to be enhanced. On the other hand, when the carcass strength coefficient K≧0.15, the reinforcing cord count, the reinforcing cord strength, and the number of carcass layers increases, which leads to a tendency for an increase in tire weight and a decrease in riding comfort. Therefore, according to this pneumatic tire, by configuring the carcass strength coefficient K of the carcass layer 6 so as to be 0 (N/mm·kPa)<K<0.15 (N/mm·kPa) in a given range of the tire width direction defined by the belt layer, the same level of riding comfort as a form in which the carcass layer is segmented can be maintained and uniformity of the tread gauge can be enhanced.

Note that a configuration is preferable in which the carcass strength coefficient K of the carcass layer 6 is configured so as to be 0.08 (N/mm·kPa)≦K≦0.13 (N/mm·kPa), because such a configuration will lead to swelling of the carcass layer 6 being further prevented, uniformity of the tread gauge being further enhanced, and the increase in tire weight and the decrease in riding comfort being suppressed.

Additionally, with the pneumatic tire of this embodiment, it is preferable that the carcass strength coefficient K is defined by a range W2 that is inward of the position P in the tire width direction, which is a position at least 10% of a maximum dimension W1 of the belt layer 7 in the tire width direction from both ends of the belt layer in the tire width direction.

Narrowing the range W2 that sets the carcass strength coefficient K so as to be inward in the tire width direction leads to the enhancement of the uniformity of the tread gauge at a center portion of the carcass layer 6 in the tire width direction, which is prone to swelling. Therefore, according to this pneumatic tire, a significant enhancement in the uniformity of the tread gauge can be obtained. Note that if the carcass strength coefficient K is defined by a range W2, which is inward in the tire width direction of ends of the belt layer 7 in the tire width direction that is not less than 10% and not more than 80% of a maximum dimension W1 of the belt layer 7 in the tire width direction, the carcass strength coefficient K of the carcass layer 6 can be set at a portion where nonuniformity of the tread gauge is more prone to occur. Therefore, a significant enhancement in the uniformity of the tread gauge can be obtained.

Additionally, with the pneumatic tire of this embodiment, the reinforcing cord count of the carcass layer 6 that defines the carcass strength coefficient K is preferably at least 3 (cords/50 mm)

The reinforcing cord count is preferably at least 3 (cords/50 mm) and more preferably from 3 to 11 (cords/50 mm) because such a configuration will lead to the prevention of the swelling of the carcass layer 6. Therefore, according to this pneumatic tire, a more significant enhancement in the uniformity of the tread gauge can be obtained.

Additionally, with the pneumatic tire of this embodiment, the reinforcing cord strength of the carcass layer 6 that defines the carcass strength coefficient K is preferably at least 2 (N/cord) and more preferably from 2 to 180 (N/cord).

It is preferable that the reinforcing cord strength be at least 2 (N/cord) because such a configuration will lead to the prevention of the swelling of the carcass layer 6. Therefore, according to this pneumatic tire, a more significant enhancement in the uniformity of the tread gauge can be obtained.

Additionally, with the pneumatic tire of this embodiment, the carcass layer 6 preferably includes the dividing portion 61 delimited by the range W2 defined by the belt layer 7 and the reinforcing portion 62 provided so as to straddle the dividing portion; and the reinforcing portion 62 is preferably defined as the carcass strength coefficient K.

When configuring the range W2 in the tread portion 2 to be the carcass strength coefficient K, in order to maintain durability of the tire, a given carcass strength coefficient is needed that reaches the bead portions 5 that are the outer sides of the range W2 in the tire width direction. Therefore, according to this pneumatic tire, strength is appropriately maintained through to the bead portions 5 that are the outer sides of the range W2 in the tire width direction due to the main body of the carcass layer 6 provided so that both ends thereof in the tire width direction fold up and around the bead cores 51 that are disposed in both of the bead portions 5 from the inner side in the tire width direction to the outer side in the tire width direction. Furthermore, by providing the dividing portion 61 and defining the carcass strength coefficient K by the reinforcing portion 62, riding comfort can be maintained and a significant enhancement in the uniformity of the tread gauge can be obtained.

### EXAMPLES

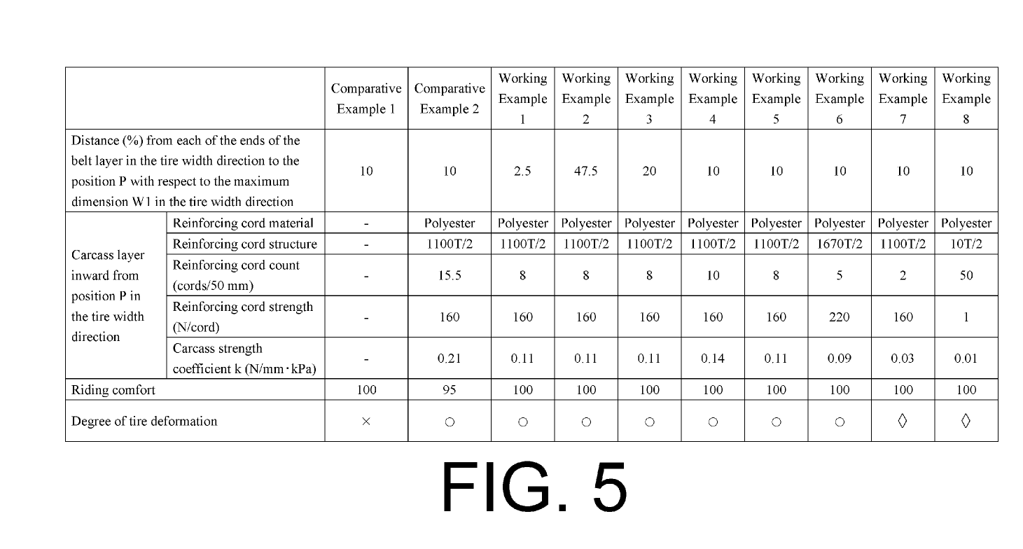

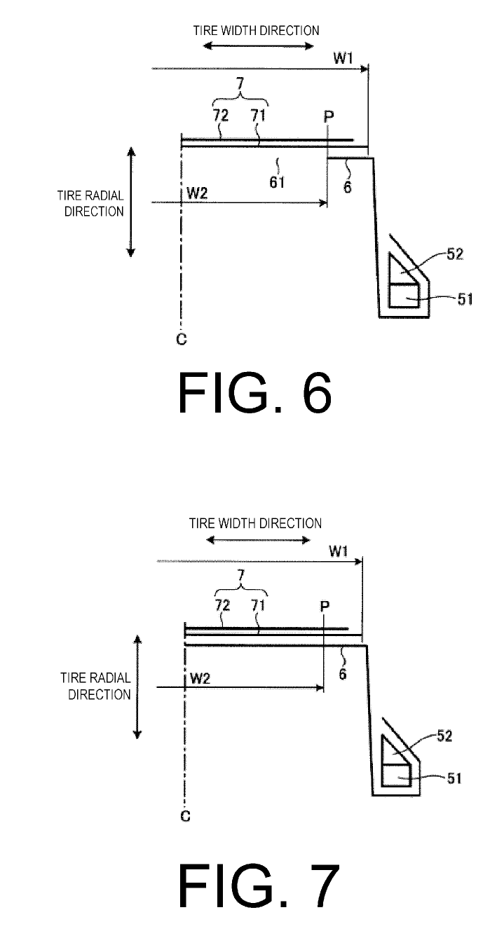

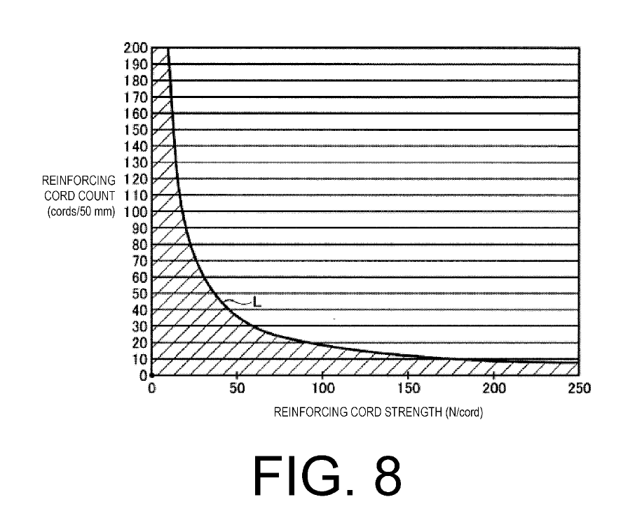

FIG. 5 is a table showing results of performance testing of pneumatic tires according to examples. FIG. 6 is a schematic meridian cross-sectional view illustrating an arrangement of a carcass layer of a pneumatic tire of Comparative Example 1 according to the examples. FIG. 7 is a schematic meridian cross-sectional view illustrating an arrangement of a carcass layer of a pneumatic tire of Comparative Example 2 according to the examples. FIG. 8 is a graph showing a range of the carcass strength coefficient of the pneumatic tire according to the examples.

In the examples, performance tests for riding comfort and for the degree of tire deformation were performed on a plurality of types of pneumatic tires under different conditions (see FIG. 5).

Pneumatic tires having a tire size of 195/65R15 were assembled on regular rims, inflated to a regular inner pressure (240 kPa), and used as the test tires. Herein, “regular rim” includes a “standard rim” defined by the Japan Automobile Tire Manufacturers Association Inc. (JATMA), a “design rim” defined by the Tire and Rim Association, Inc. (TRA), and a “measuring rim” defined by the European Tyre and Rim Technical Organisation (ETRTO). “Regular inner pressure” includes “maximum air pressure” defined by JATMA, the maximum value in “tire load limits at various cold inflation pressures” defined by TRA, and “inflation pressure” defined by ETRTO.

The following method was used for evaluating riding comfort. The test tires described above were mounted on a test vehicle (2.5L class passenger car, manufactured in Japan). Then, this test vehicle was driven on an uneven, straight test course at a speed of 50 km/h. Sensory evaluations (five levels) were performed by three experienced drivers. In this evaluation, the index value of the pneumatic tire of the Conventional Example was set as the standard (100). Higher index values indicate superior riding comfort.

The following method was used for evaluating the degree of tire deformation. Thicknesses of the tread at the tire equatorial plane and the position P were measured in a cross-section in the meridian direction of the test tires described above after manufacturing. When the difference between these measurements was 3 mm or more, an evaluation of “x” was given; not less than 1.5 but less than 3 mm, “⋄” was given; and less than 1.5 mm, “∘” was given. Tires evaluated as “⋄” or “∘” had a low degree of tire deformation and, thus, were preferable.

As illustrated in FIG. 6, with the pneumatic tire of Comparative Example 1, only the dividing portion 61 is provided in the carcass layer 6 in the tread portion. With the pneumatic tire of Comparative Example 1, the carcass layer 6 does not exist in the range W2 inward of the position P in the tire width direction. Additionally, as illustrated in FIG. 7, with the pneumatic tire of Comparative Examples 2, the carcass layer 6 is configured so as to be continuous in the tire width direction in the tread portion. With the pneumatic tire of Comparative Example 2, the carcass layer 6 is present in the range W2 inward of the position P in the tire width direction, but the carcass strength coefficient K is outside the prescribed range.

As illustrated in FIG. 1, with the pneumatic tires of Working Examples 1 to 8, the carcass layer 6 has the dividing portion 61 and the reinforcing portion 62 in the range W2 that is inward of the position P in the tire width direction in the tread portion, and the carcass strength coefficient K is provided within the prescribed range. Moreover, with the pneumatic tire of Working Example 1, a distance (%) from each of the ends of the belt layer in the tire width direction to the position P is 2.5% with respect to the maximum dimension W1 in the tire width direction (the sum from both ends is 5%). With the pneumatic tire of Working Example 2, a distance (%) from each of the ends of the belt layer in the tire width direction to the position P is 47.5% with respect to the maximum dimension W1 in the tire width direction (the sum from both ends is 95%). With the pneumatic tire of Working Example 3, a distance (%) from each of the ends of the belt layer in the tire width direction to the position P is 20% with respect to the maximum dimension W1 in the tire width direction (the sum from both ends is 40%). With the pneumatic tires of Working Examples 4 to 8, a distance (%) from each of the ends of the belt layer in the tire width direction to the position P is 10% with respect to the maximum dimension W1 in the tire width direction (the sum from both ends is 20%).

Additionally, as shown in FIG. 8, with the range 0 (N/mm·kPa)<K<0.15 (N/mm·kPa) of the carcass strength coefficient K, the carcass strength coefficient K has a smaller hatching range than the reference line L that represents 0.15 (N/mm·kPa), due to the relationship between the reinforcing cord count and the reinforcing cord strength. Note that in Comparative Example 1, the reinforcing cord count and the reinforcing cord strength are shown as being 0 because the carcass layer 6 does not exist in the range W2. Comparative Example 2 is outside the range of the hatching of the carcass strength coefficient K, above the reference line L, because the carcass strength coefficient K is outside the prescribed range.

As shown by the test results of FIG. 5, it is clear that with the pneumatic tires of Working Examples 1 to 8 riding comfort is maintained, the degree of tire deformation is small, and the uniformity of the tread gauge is enhanced.

What is claimed is:

1. A pneumatic tire comprising a carcass layer wherein a plurality of reinforcing cords is arranged in a tire circumferential direction and ends thereof in a tire width direction extend to bead cores disposed in bead portions of both sides; and a belt layer, in a tread portion, including at least one layer provided on an outer side in a tire radial direction of the carcass layer, wherein
a range W2, which is inward in the tire width direction of ends of the belt layer in the tire width direction, is not less than 5% and not more than 95% of a maximum dimension W1 of the belt layer in the tire width direction; and
a carcass strength coefficient K of the carcass layer defined by the formula [carcass strength coefficient K (N/mm·kPa)]=[reinforcing cord count (cords/mm)]×[reinforcing cord strength (N/cord)]×[number of carcass layers]÷[maximum air pressure (kPa)] is such that 0 (N/mm·kPa)<K<0.15 (N/mm·kPa).

2. The pneumatic tire according to claim 1, wherein the carcass strength coefficient K is calculated using the range W2, wherein the range W2 is inward in the tire width direction of a position that is at least 10% of the maximum dimension of the belt layer in the tire width direction from both ends of the belt layer in the tire width direction.

3. The pneumatic tire according to claim 2, wherein the reinforcing cord count of the carcass layer used in calculating the carcass strength coefficient K is at least 3 (cords/50 mm)

4. The pneumatic tire according to claim 1, wherein the reinforcing cord count of the carcass layer used in calculating the carcass strength coefficient K is at least 3 (cords/50 mm)

5. The pneumatic tire according to claim 4, wherein the reinforcing cord strength of the carcass layer used in calculating the carcass strength coefficient K is at least 2 (N/cord).

6. The pneumatic tire according to claim 5, wherein the carcass layer comprises a dividing portion delimited by the range defined by the belt layer, and a reinforcing portion provided across the dividing portion, wherein the reinforcing portion is used in calculating the carcass strength coefficient K.

7. The pneumatic tire according to claim 1, wherein the reinforcing cord strength of the carcass layer used in calculating the carcass strength coefficient K is at least 2 (N/cord).

8. The pneumatic tire according to claim 7, wherein the carcass layer comprises a dividing portion delimited by the range defined by the belt layer, and a reinforcing portion provided across the dividing portion, wherein the reinforcing portion is used in calculating the carcass strength coefficient K.

9. The pneumatic tire according to claim 1, wherein the carcass layer comprises a dividing portion delimited by the range defined by the belt layer, and a reinforcing portion provided across the dividing portion, wherein the reinforcing portion is used in calculating the carcass strength coefficient K.

10. The pneumatic tire according to claim 1, wherein the carcass strength coefficient K of the carcass layer is configured for the range W2.

11. The pneumatic tire according to claim 1, wherein the carcass strength coefficient K of the carcass layer is configured so as to be 0.08 (N/mm·kPa)≦K≦0.13 (N/mm·kPa).

12. The pneumatic tire according to claim 1, wherein the reinforcing cord count of the carcass layer used in calculating the carcass strength coefficient K is from 3 to 11 (cords/50 mm)

13. The pneumatic tire according to claim 1, wherein the reinforcing cord strength of the carcass layer used in calculating the carcass strength coefficient K is from 2 to 180 (N/cord).

14. The pneumatic tire according to claim 1, wherein ends of the carcass layer in the tire width direction are folded up and around the bead cores disposed in the bead portions from the inner side in the tire width direction to the outer side in the tire width direction.

15. The pneumatic tire according to claim 1, wherein the range W2 is not less than 20% and not more than 40% of the maximum dimension W1 of the belt layer in the tire width direction.

16. The pneumatic tire according to claim 1, wherein the reinforcing cord count of the carcass layer used in calculating the carcass strength coefficient K is from 5 to 8 (cords/50 mm)

17. The pneumatic tire according to claim 1, wherein the carcass strength coefficient K of the carcass layer is configured so as to be 0.09 (N/mm·kPa)≦K≦0.11 (N/mm·kPa),

18. The pneumatic tire according to claim 1, wherein the reinforcing cords are provided in the tire circumferential direction at an angle from approximately 85° to 95° with respect to a tire equator C.

19. The pneumatic tire according to claim 1, wherein the belt layer comprises a multi-layer structure including a plurality of belt layers, wherein cords of the belt layers are provided so as to reciprocally cross.

20. The pneumatic tire according to claim 1, wherein the carcass strength coefficient K is defined by the range W2, which is not less than 10% and not more than 80% of the maximum dimension W1 of the belt layer in the tire width direction, and the carcass strength coefficient K of the carcass layer is set at a portion where nonuniformity of the tread gauge is prone to occur.
